(19) United States
(12) Patent Application Publication
(10) Pub. No.: US 2020/0215930 A1
(43) Pub. Date: Jul. 9, 2020

(54) CONTROL APPARATUS, CONTROL METHOD, AND COMPUTER PROGRAM

(71) Applicant: SUMITOMO ELECTRIC INDUSTRIES, LTD., Osaka-shi, Osaka (JP)

(72) Inventor: Tatsuya IZUMI, Osaka-shi (JP)

(73) Assignee: SUMITOMO ELECTRIC INDUSTRIES, LTD., Osaka-shi, Osaka (JP)

(21) Appl. No.: 16/636,745

(22) PCT Filed: Apr. 13, 2018
(86) PCT No.: PCT/JP2018/015556

§ 371 Date: Feb. 5, 2020

(30) Foreign Application Priority Data
Aug. 10, 2017 (JP) 2017-155930

(51) Int. Cl. B60L 58/13; B60L 53/30; B60L 53/10

(52) U.S. Cl. CPC B60L 58/13; B60L 53/11; B60L 53/305

(57) ABSTRACT

A control apparatus includes: a communication unit configured to communicate with one or a plurality of on-vehicle control devices via an in-vehicle communication line; a first acquisition unit configured to acquire a battery's state of charge that supplies power to on-vehicle control devices; a second acquisition unit configured to acquire an estimated amount of power consumption in each on-vehicle control device up to a time point when update of a control program in on-vehicle control device is completed; a determination unit configured to determine whether or not an expected state of the battery's charge at time point of update completion is equal to or larger than a threshold, on the basis of the state of the battery's charge and estimated amount of power consumption; and a control unit configured to instruct one or a plurality of on-vehicle control devices about devices' operations to be controlled by the on-vehicle control devices.

### TECHNICAL FIELD

The present invention relates to a control apparatus, a control method, and a computer program.

This application claims priority on Japanese Patent Application No. 2017-155930 filed on Aug. 10, 2017, the entire contents of which are incorporated herein by reference.

### BACKGROUND ART

In the automotive field in recent years, vehicles have progressed in functionality, and a diverse range of devices are installed on vehicles. Accordingly, vehicles are equipped with large numbers of control devices, so-called ECUs (Electronic Control Units), for controlling these on-vehicle devices.

Examples of types of ECUs include: travel-related ECUs that control an engine, a brake, EPS (Electric Power Steering), and the like in response to operations on an accelerator, a brake, and a handle; body-related ECUs that control ON/OFF of interior lights and headlights, sound of an alarm unit, and the like in response to switch operations performed by an occupant; and meter-related ECUs that control operations of meters arranged near the driver's seat.

Generally, each ECU consists of an arithmetic processing unit such as a microcomputer, and implements a control of an on-vehicle device by reading out a control program stored in a ROM (Read Only Memory), and executing the read control program.

Control programs of ECUs may differ depending on the shipping destinations, grades, etc., of vehicles. Therefore, old versions of control programs need to be overwritten with new versions of control programs in response to upgrading of control programs. Further, data required for execution of the control programs, such as map information and control parameters, also need to be overwritten.

For example, Patent Literature 1 discloses a technique (on-line update function) of downloading an update program via a network, and performing update of a program by using the update program. In addition, Patent Literature 2 discloses a technique of on-line update in which on-line update is started after confirming that the state of charge of a battery is higher than power consumption required for an update process by a predetermined value or more.

### CITATION LIST

### Patent Literature

PATENT LITERATURE 1: Japanese Laid-Open Patent Publication No. 2015-37938

PATENT LITERATURE 2: Japanese Laid-Open Patent Publication No. 2013-84143

### SUMMARY OF INVENTION

According to one embodiment, a control apparatus includes: a communication unit configured to communicate with one or a plurality of on-vehicle control devices via an in-vehicle communication line; a first acquisition unit configured to acquire a state of charge of a battery that supplies power to the on-vehicle control devices; a second acquisition unit configured to acquire an estimated amount of power consumption in each on-vehicle control device up to a time point when update of a control program in the on-vehicle control device is completed; a determination unit configured to execute a first determination process of determining whether or not an expected state of charge of the battery at the time point of update completion is equal to or larger than a threshold, on the basis of the state of charge of the battery and the estimated amount of power consumption; and a control unit configured to instruct, via the communication unit, the one or a plurality of on-vehicle control devices about operations of devices to be controlled by the on-vehicle control devices. In a case where it has been determined, at a first time point during the update of the control program, that the estimated state of charge is smaller than the threshold, the control unit causes a user interface device to perform an information output that urges a charging start operation for the battery.

According to another embodiment, provided is a control method for an on-vehicle control device by a control apparatus configured to communicate with the on-vehicle control device via an in-vehicle communication line. The method includes: a step of acquiring a state of charge of a battery that is able to supply power to the on-vehicle control devices; a step of acquiring an estimated amount of power consumption in each on-vehicle control device up to a time point when update of a control program in the on-vehicle control device is completed; a step of determining whether or not an expected state of charge of the battery at the time point of update completion is equal to or larger than a threshold, on the basis of the state of charge of the battery and the estimated amount of power consumption during the update of the control program; and a step of instructing the on-vehicle control device about an operation of a device to be controlled by the on-vehicle control device. The instruction step includes causing a user interface device to perform an information output that urges a charging start operation for the battery, in a case where it has been determined, during the update of the control program, that the estimated state of charge is smaller than the threshold during the update of the control program.

According to still another embodiment, provided is a computer program for causing a computer to function as a control apparatus configured to communicate with an on-vehicle control device via an in-vehicle communication line. The computer program causes the computer to function as: a first acquisition unit configured to acquire a state of charge of a battery that supplies power to the on-vehicle control device; a second acquisition unit configured to acquire an estimated amount of power consumption in the on-vehicle control device up to a time point when update of a control program in the on-vehicle control device is completed; a determination unit configured to execute a determination process of determining whether or not an expected state of charge of the battery at the time point of update completion is equal to or larger than a threshold, on the basis of the state of charge of the battery and the estimated amount of power consumption; and a control unit configured to instruct the on-vehicle control device about an operation of a device to be controlled by the on-vehicle control device. In a case where it has been determined, during the update of the control program, that the estimated state of charge is smaller than the threshold, the control unit causes a user interface device to perform an information output that urges a charging start operation for the battery.

### BRIEF DESCRIPTION OF DRAWINGS

FIG. 1 shows an overall configuration of a program updating system.

FIG. 2 is a block diagram showing an internal configuration of a gateway.

FIG. 3 is a block diagram showing an internal configuration of an ECU.

FIG. 4 is a block diagram showing an internal configuration of a management server.

FIG. 5 is a sequence diagram showing an example of a flow of on-line update of a control program which is executed in the program update system.

FIG. 6 is a schematic diagram showing an example of a configuration of a vehicle according to a first embodiment.

FIG. 7 is a flowchart showing a specific example of an update control process in step S6 in FIG. 5.

FIG. 8 is a flowchart showing a specific example of the update control process in step S6 in FIG. 5.

FIG. 9 is a schematic diagram showing an example of a configuration of a vehicle according to a third embodiment.

### DESCRIPTION OF EMBODIMENTS

### Problems to be Solved by the Present Disclosure

The on-line update disclosed in Literature 1 is generally started while the engine is stopped. Therefore, if the state of charge of the battery is small, the update may fail due to power shortage during the update, or the state of charge of the battery may become insufficient for traveling, which may prohibit the vehicle from traveling. Meanwhile, when the technique of Literature 2 is used, on-line update is started if the state of charge of the battery at the start of the on-line update is ensured. Therefore, as long as the power consumption state at the start of the update is maintained in the vehicle, it is possible to avoid power shortage during the update process, and shortage of the state of charge of the battery for traveling when the update is completed.

However, even when shortage of the state of charge of the battery was not estimated at the start of the update, the state of charge of the battery may be considerably reduced depending on the usage states of other devices, such as an air conditioner being operated and an audio being operated during the update. That is, even when the technique of Literature 2 is used, power shortage may occur during the update depending on the power consumption state after the start of the update. In this case, the update may be interrupted and failed, or the update program may be damaged. Further, even when the update process has been completed, shortage of power required for traveling may occur after the update completion, which may prohibit the vehicle from traveling.

An object according to an aspect of the present disclosure is to provide a control apparatus, a control method, and a computer program which are able to avoid the situation that the state of charge of the battery is insufficient after update of a control program has been completed.

### Effect of the Present Disclosure

According to this disclosure, it is possible to avoid the situation that the state of charge of the battery is insufficient after update of a control program has been completed.

### DESCRIPTION OF EMBODIMENTS

Embodiments of the present disclosure include at least the following.

(1) A control apparatus included in the present embodiments includes: a communication unit configured to communicate with one or a plurality of on-vehicle control devices via an in-vehicle communication line; a first acquisition unit configured to acquire a state of charge of a battery that supplies power to the on-vehicle control devices; a second acquisition unit configured to acquire an estimated amount of power consumption in each on-vehicle control device up to a time point when update of a control program in the on-vehicle control device is completed; a determination unit configured to execute a first determination process of determining whether or not an expected state of charge of the battery at the time point of update completion is equal to or larger than a threshold, on the basis of the state of charge of the battery and the estimated amount of power consumption; and a control unit configured to instruct, via the communication unit, the one or a plurality of on-vehicle control devices about operations of devices to be controlled by the on-vehicle control devices. In a case where it has been determined, at a first time point during the update of the control program, that the estimated state of charge is smaller than the threshold, the control unit causes a user interface device to perform an information output that urges a charging start operation for the battery.

When the state of charge of the battery is estimated by use of the estimated amount of power consumption in each on-vehicle control device, the state of charge of the battery at the time of update completion is estimated with high accuracy. When the state of charge of the battery at the time point of update completion is smaller than the threshold, the user is urged to perform the charging start operation. When the charging start operation is performed, the battery is charged. This avoids the situation that the state of charge of the battery becomes insufficient after the update completion.

(2) Preferably, the user interface device includes a user interface device outside a vehicle. When a user is not inside the vehicle, the control unit causes the user interface device outside the vehicle to perform the information output.

Thus, when the user is outside the vehicle, the user is urged to perform the charging start operation by the user interface device, outside the vehicle, which can be checked by the user. Therefore, even when the user is outside the vehicle, the user is remotely urged to perform the user operation, whereby the battery is charged with higher reliability. This avoids the situation that the state of charge of the battery becomes insufficient after the update completion.

(3) Preferably, the user interface device includes an on-vehicle user interface device. When a user is inside a vehicle, the control unit causes the on-vehicle user interface device to perform the information output.

Thus, when the user is inside the vehicle, the user is urged to perform the charging start operation by the on-vehicle user interface device which can be checked by the user. Therefore, the battery is charged with higher reliability. This avoids the situation that the state of charge of the battery becomes insufficient after the update completion.

(4) Preferably, when charging of the battery is started according to the charging start operation, the determination unit executes the first determination process at a second time point later than the first time point. In a case where it has been determined at the second time point that the estimated state of charge is equal to or larger than the threshold, the control unit causes a mechanism for supplying power to the battery to stop supply of power to the battery.

When the vehicle is a so-called engine car, the mechanism for supplying power to the battery includes an alternator. In this case, in order to stop supply of power from the alternator to the battery, the control unit stops the operation of the engine to which the alternator is connected. Meanwhile, when the vehicle is a so-called hybrid car or an electric car, the mechanism for supplying power to the battery includes a DC/DC converter that steps down a voltage when power is supplied from a high-voltage battery for traveling to an auxiliary battery that supplies power to the on-vehicle control device. In this case, in order to stop supply of power from the high-voltage battery to the auxiliary battery, the control unit turns off the DC/DC converter. Thus, charging is stopped when it is determined that the battery has been charged until the estimated state of charge of the battery at the time point of update completion is equal to or larger than the threshold. This avoids the situation that the state of charge of the battery becomes insufficient after the update completion, and avoids excessive charging.

(5) Preferably, in a case where it has been determined at the first time point that the estimated state of charge is equal to or larger than the threshold, the determination unit periodically executes the first determination process after the first time point until reaching the time point of update completion.

Thus, in the case where the power consumption state of the on-vehicle control device is changed after the first time point and thereby the estimated state of charge becomes smaller than the threshold, the user is urged to perform the user operation that instructs charging of the battery. Therefore, it is possible to cope with a change in the power consumption state of the on-vehicle control device.

(6) Preferably, the determination unit executes a second determination process of determining whether or not the state of charge of the battery is equal to or larger than the threshold. In a state where it has been determined at the first time point that the state of charge of the battery is smaller than the threshold, the control unit causes the on-vehicle control device that is updating the control program to stop the update. In a state where it has been determined at the first time point that the state of charge of the battery is equal to or larger than the threshold, the determination unit executes the first determination process.

Thus, the update of the control program is stopped when the state of charge of the battery becomes smaller than the threshold during the update. This avoids the situation that the state of charge of the battery becomes insufficient during the update.

(7) Preferably, in a case where it has been determined at the first time point that the estimated state of charge is smaller than the threshold and the charging start operation is not performed at the first time point, the determination unit periodically executes the second determination process after the first time point.

In the case where the estimated state of charge is smaller than the threshold at the first time point and the charging start operation has not been performed, the state of charge of the battery may become smaller than the threshold when the update continues. By periodically executing the second determination process thereafter, it is possible to stop the update when the state of charge of the battery becomes smaller than the threshold. This avoids the situation that the state of charge of the battery becomes insufficient during the update.

(8) Preferably, the charging start operation includes one of an operation of instructing engine start, and an operation of turning on a DC/DC converter that steps down a voltage when power is supplied from a battery for traveling to an auxiliary battery.

When the vehicle is an engine car which is called a conventional car, the alternator generates power when the engine is started, and the battery is charged. Meanwhile, when the vehicle is a hybrid car, power is supplied from the battery for traveling to the auxiliary battery when the converter is turned on, and the auxiliary battery is charged.

(9) Preferably, the second acquisition unit calculates the estimated amount of power consumption on the basis of an amount of power consumption required for the update of the control program, and an amount of power estimated to be consumed in a period from the first time point to the time point of update completion, by an on-vehicle control device other than the on-vehicle control device that updates the control program.

Since the estimated amount of power consumption is calculated by use of the amount of power estimated to be consumed by the on-vehicle control device other than the on-vehicle control device that updates the control program, the estimated state of charge of the battery is calculated with high accuracy.

(10) Preferably, based on a power consumption state, at the first time point, of the on-vehicle control device other than the on-vehicle control device that updates the control program, the second acquisition unit estimates an amount of power consumption in the on-vehicle control device up to the time point of update completion.

Since the amount of power consumption is estimated based on the power consumption state, at the first time point, of the on-vehicle control device other than the on-vehicle control device that updates the control program, the estimated state of charge of the battery is calculated with high accuracy.

(11) A control method included in the present embodiments is a method of controlling an on-vehicle control device in a control apparatus according to any one of the above (1) to (10).

This control method has the same effects as the control apparatuses according to the above (1) to (10).

(12) A computer program included in the above embodiments causes a computer to function as a control apparatus according to any one of the above (1) to (10).

This computer program has the same effects as the control apparatuses according to the above (1) to (10).

### DETAILED DESCRIPTION OF EMBODIMENTS

Hereinafter, preferred embodiments will be described with reference to the drawings. In the following description, the same reference numerals refer to the same components and constituent elements. The names and functions thereof are also the same. Therefore, repeated description thereof is not necessary.

### First Embodiment

### [Overall Configuration of System]

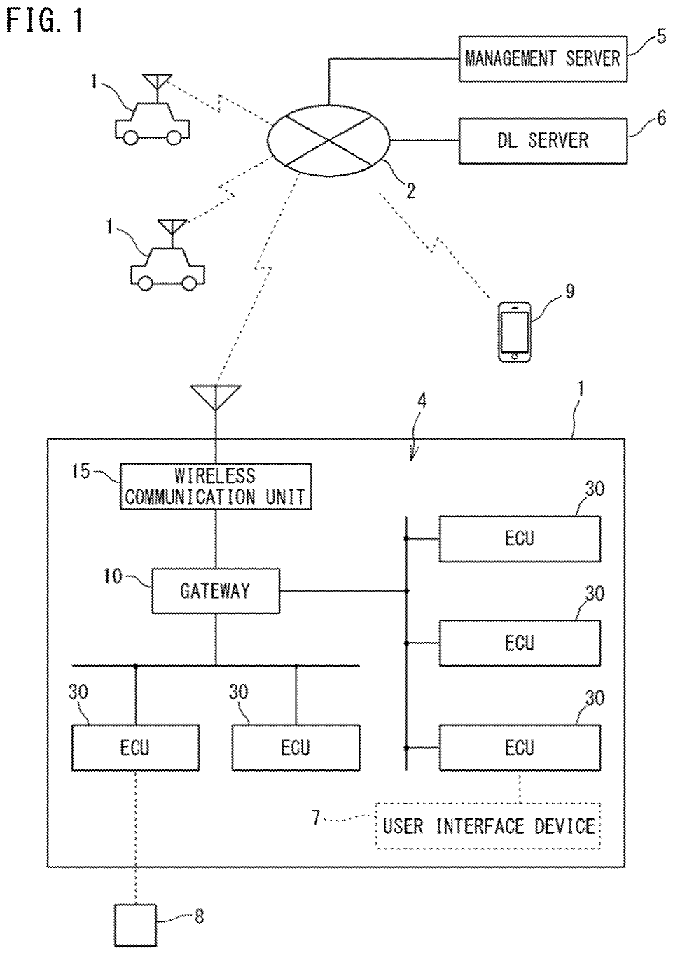

FIG. 1 is a diagram showing an overall configuration of a program updating system according to an embodiment of the present disclosure.

As shown in FIG. 1, the program updating system of this embodiment includes vehicles 1, a management server 5, and a DL (download) server 6, which are communicable with each other via a wide-area communication network 2. Further, a communication device 9 such as a smartphone or a tablet terminal, which is carried by a user, is also communicable with the vehicles 1, etc. via the wide-area communication network 2.

The management server 5 manages update information of each vehicle 1. The DL server 6 stores therein an update program. The management server 5 and the DL server 6 are operated by, for example, the automobile manufacturer of the vehicles 1, and are able to communicate with large numbers of vehicles 1 owned by users registered as members in advance.

Each vehicle 1 is equipped with: an in-vehicle network (communication network) 4 including a plurality of ECUs 30 connected by in-vehicle communication lines, and a gateway 10; a wireless communication unit 15; and various on-vehicle devices (not shown) controlled by the respective ECUs 30.

The on-vehicle devices include a user interface device 7 such as a display or a speaker.

In each vehicle 1, there are communication groups each consisting of a plurality of ECUs 30 bus-connected to a common in-vehicle communication line, and the gateway 10 relays communication between the communication groups.

The plurality of ECUs 30 includes a so-called body-related ECU which is wirelessly communicable with a control terminal 8, also-called a remote-control key, which accepts a user operation instructing engine start or the like. The body-related ECU is operated according to an instruction included in a radio signal transmitted from the control terminal 8.

The wireless communication unit 15 is communicably connected to the wide-area communication network 2 such as a mobile phone network, and is connected to the gateway 10 by an in-vehicle communication line. The wireless communication unit 15 receives information from external devices such as the management server 5 and the DL server 6 via the wide-area communication network 2, and the gateway 10 transmits the information to the ECUs 30 via the in-vehicle communication lines 16.

The gateway 10 transmits information acquired from the ECUs 30 to the wireless communication unit 15, and the wireless communication unit 15 transmits the information to the external devices such as the management server 5.

The ECUs 30 exchange information via the in-vehicle communication line.

As for the wireless communication unit 15 mounted in the vehicle 1, apart from an on-vehicle exclusive communication terminal, a device possessed by the user of the vehicle 1, such as a mobile phone, a smartphone, a tablet terminal, or a notebook PC (Personal Computer), is adoptable.

FIG. 1 shows the case where the gateway 10 communicates with the external devices via the wireless communication unit 15. However, when the gateway 10 has a function of wireless communication, the gateway 10 itself may be configured to perform wireless communication with the external devices such as the management server 5.

In the program updating system shown in FIG. 1, the management server 5 and the DL server 6 are configured as separate servers. However, these servers 5 and 6 may be configured as a single server unit. Each of the management server 5 and the DL server 6 may be composed of a plurality of devices.

### [Internal Configuration of Gateway]

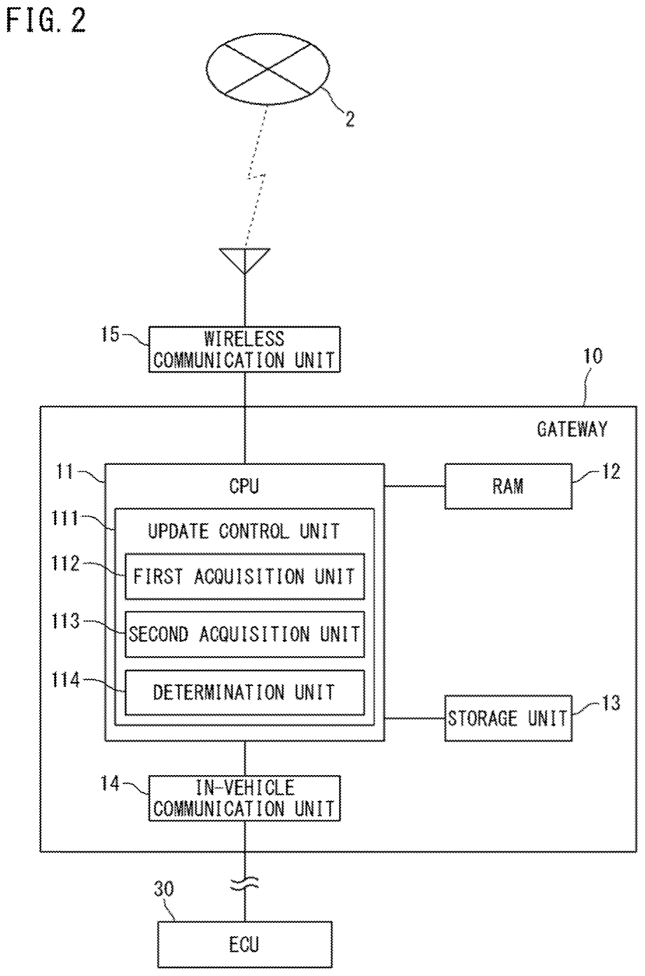

FIG. 2 is a block diagram showing the internal configuration of the gateway 10.

As shown in FIG. 2, the gateway 10 includes a CPU 11, a RAM (Random Access Memory) 12, a storage unit 13, an in-vehicle communication unit 14, and the like. Although the gateway 10 is connected to the wireless communication unit 15 via the in-vehicle communication line, the gateway 10 and the wireless communication unit 15 may be configured as a single unit.

The CPU 11 causes the gateway 10 to function as a relay device for relaying various kinds of information by reading out one or a plurality of programs stored in the storage unit 13 to the RAM 12, and executing the read programs.

The CPU 11 can execute a plurality of programs in parallel by switching between the programs in a time-sharing manner, for example. The CPU 11 may be a CPU representing a plurality of CPU groups. In this case, a function to be implemented by the CPU 11 is a function to be implemented by the plurality of CPU groups in cooperation with each other. The RAM 12 consists of a memory element such as a SRAM (Static RAM) or a DRAM (Dynamic RAM), and temporarily stores therein programs to be executed by the CPU 11, data required in executing the programs, and the like.

A computer program implemented by the CPU 11 can be transferred in a state of being recorded in a well-known recording medium such as a CD-ROM or a DVD-ROM, or can be transferred by information transmission from a computer device such as a server computer.

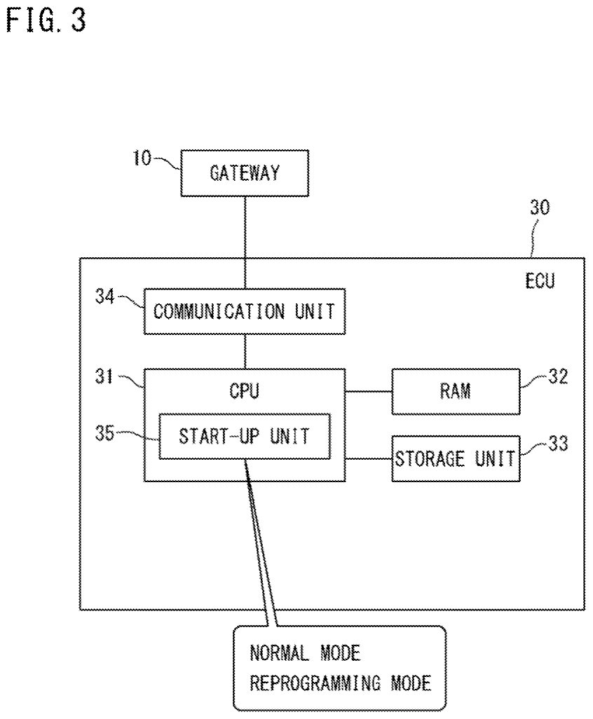

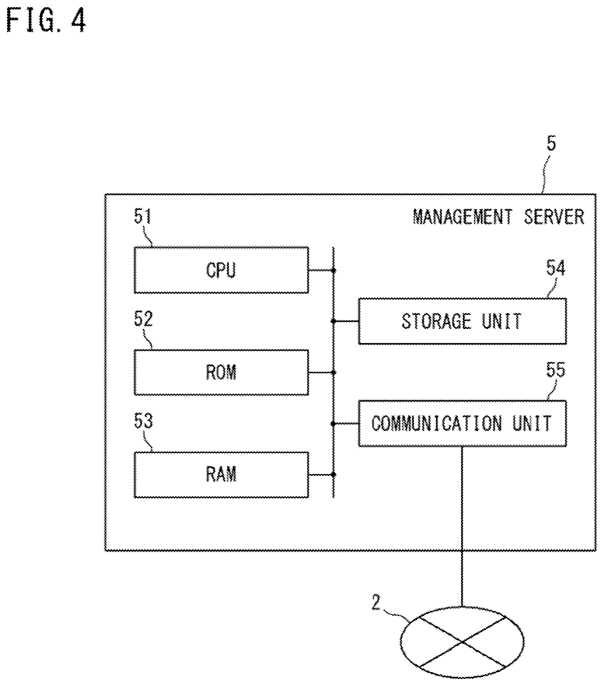

In this aspect, the same applies to a computer program to be executed by a CPU 31 of the ECU 30 (refer to FIG. 3) described later, and a computer program to be executed by a CPU 51 of the management server 5 (refer to FIG. 4) described later.

In the following description, transfer (transmission) of data from a higher-order device to a lower-order device is also referred to as “download”.

The storage unit 13 consists of, for example, a nonvolatile memory element such as a flash memory or an EEPROM (Electrically Erasable Programmable Read Only Memory). The storage unit 13 stores therein programs to be executed by the CPU 11, data required in executing the programs, and the like. The storage unit 13 also stores therein update programs and the like, for the respective ECUs 30, which have been received from the DL server 6 and are to be downloaded.

The plurality of ECUs 30 are connected to the in-vehicle communication unit 14 via the in-vehicle communication lines arranged in the vehicle 1. The in-vehicle communication unit 14 performs communication (also referred to as CAN communication) with the ECUs 30 in accordance with the CAN (Controller Area Network) standard, for example. Apart from the CAN, the in-vehicle communication unit 14 may adopt other communication standards such as CANFD (CAN with Flexible Data Rate), LIN (Local Interconnect Network), Ethernet (registered trademark), MOST (Media Oriented Systems Transport: MOST is a registered trademark), etc. Among the plurality of in-vehicle communication lines, some communication lines may be based on different communication standards.

The in-vehicle communication unit 14 transmits information provided from the CPU 11 to target ECUs 30, and provides information received from the ECUs 30 to the CPU 11. Apart from the aforementioned communication standards, the in-vehicle communication unit 14 may communicate with the ECUs 30 in accordance with other communication standards available for the in-vehicle network 4.

The wireless communication unit 15 consists of a wireless communication apparatus including an antenna and a communication circuit that executes transmission/reception of radio signals through the antenna. The wireless communication unit 15 is able to communicate with the external devices when connected to the wide-area communication network 2 such as a mobile phone network.

The wireless communication unit 15 transmits information provided from the CPU 11 to the external devices such as the management server 5 via the wide-area communication network 2 formed by base stations (not shown), and provides information received from the external devices to the CPU 11.

Instead of the wireless communication unit 15 shown in FIG. 2, a wired communication unit that functions as a relay device in the vehicle 1 may be adopted. The wired communication unit has a connector to which a communication cable conforming to a standard such as USB (Universal Serial Bus) or RS232C is connected, and performs wired communication with another communication device connected thereto via the communication cable.

When the other communication device and an external device such as the management server 5 are able to perform wireless communication via the wide-area communication network 2, the external device becomes communicable with the gateway 10 through a communication path including the external device, the other communication device, the wired communication unit, and the gateway 10 in this order.

### [Internal Configuration of ECU]

FIG. 3 is a block diagram showing an internal configuration of each ECU 30.

As shown in FIG. 3, the ECU 30 includes a CPU 31, a RAM 32, a storage unit 33, a communication unit 34, and the like. The ECUs 30 are on-vehicle control devices that individually control target equipment installed in the vehicle 1. Examples of the types of the ECUs 30 include a power supply control ECU, an engine control ECU, a steering control ECU, and a door lock control ECU.

The CPU 31 controls the operation of target equipment that the CPU 31 is in charge of, by reading out one or a plurality of programs previously stored in the storage unit 33 to the RAM 32, and executing the read programs. The CPU 31 may also be a CPU representing a plurality of CPU groups, and a control to be performed by the CPU 31 may be a control to be performed by the plurality of CPU groups in cooperation with each other.

The RAM 32 consists of a memory element such as a SRAM or a DRAM, and temporarily stores therein the programs to be executed by the CPU 31, data required in executing the programs, and the like.

The storage unit 33 consists of, for example, a nonvolatile memory element such as a flash memory or an EEPROM, or a magnetic storage device such as a hard disk.

The storage unit 33 stores therein the programs to be read and executed by the CPU 31. Examples of information stored in the storage unit 33 include: a computer program that causes the CPU 31 to execute information processing for controlling target equipment that is an in-vehicle control target; and a control program that is data, such as parameters and map information, to be used when the computer program is executed.

The gateway 10 is connected to the communication unit 34 via the in-vehicle communication line arranged in the vehicle 1. The communication unit 34 communicates with the gateway 10 in accordance with a standard such as CAN, Ethernet, or MOST, for example.

The communication unit 34 transmits information provided from the CPU 31 to the gateway 10, and provides information received from the gateway 10 to the CPU 31. The communication unit 34 may communicate with the gateway 10 in accordance with other communication standards that are used for the on-vehicle network, apart from the above communication standards.

The CPU 31 of the ECU 30 includes a start-up unit 35 that switches the mode of control performed by the CPU 31, between a “normal mode” and a “reprogramming mode”.

The normal mode is a control mode in which the CPU 31 of the ECU 30 executes original control for the target equipment (e.g., engine control for a fuel engine, or door lock control for a door lock motor).

The reprogramming mode is a control mode for updating the control program used for control of the target equipment.

That is, the reprogramming mode is a control mode in which the CPU 31 performs erasing/overwriting of data of the control program from/on an ROM area in the storage unit 33. Only when the CPU 31 is in this control mode, the CPU 31 is allowed to update the control program stored in the ROM area in the storage unit 33 to a new version of the control program.

When the CPU 31, in the reprogramming mode, writes the new version of the control program into the storage unit 33, the start-up unit 35 temporarily restarts (resets) the ECU 30, and executes a verifying process on a storage area where the new version of the control program has been written.

After completion of the verifying process, the start-up unit 35 causes the CPU 31 to operate with the updated control program.

The process of downloading the update program from the DL server 6 through the gateway 10 to the ECU 30 and then updating the control program by using the update program, is also referred to as “on-line update”.

### [Internal Structure of Management Server]

FIG. 4 is a block diagram showing the internal structure of the management server 5.

As shown in FIG. 4, the management server 5 includes a CPU 51, an ROM 52, an RAM 53, a storage unit 54, a communication unit 55, and the like.

By reading out one or a plurality of programs previously stored in the ROM 52 to the RAM 53, and executing the read programs, the CPU 51 controls the operation of each hardware component, and causes the management server 5 to function as an external device that is able to communicate with the gateway 10. The CPU 51 may also be a CPU representing a plurality of CPU groups, and a function to be implemented by the CPU 51 may be a function to be implemented by the plurality of CPU groups in cooperation with each other.

The RAM 53 consists of a memory element such as an SRAM or a DRAM, and temporarily stores therein programs to be executed by the CPU 51, data required in executing the programs, and the like.

The storage unit 54 consists of, for example, a nonvolatile memory element such as a flash memory or an EEPROM, or a magnetic storage device such as a hard disk.

The communication unit 55 consists of a communication device that executes a communication process in accordance with a predetermined communication standard. The communication unit 55 executes the communication process when connected to the wide-area communication network 2 such as a mobile phone network. The communication unit 55 transmits information provided from the CPU 51 to external devices via the wide-area communication network 2, and provides information received via the wide-area communication network 2 to the CPU 51.

### [Control Program Updating Sequence]

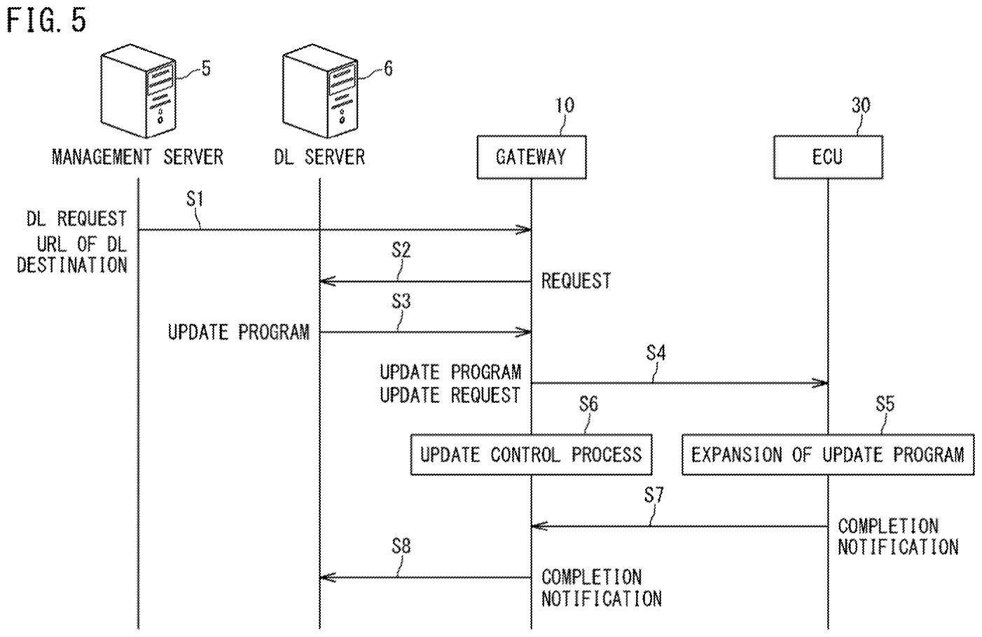

FIG. 5 is a sequence diagram showing an example of a flow of control program on-line update which is executed in the program update system of the present embodiment. One or a plurality of update programs are stored in the DL server 6. As one example, the management server 5 determines a timing to update a control program of an ECU of a vehicle 1 registered in advance. The update timing may be set by, for example, the automobile manufacturer of the vehicle 1.

The control program includes not only the program itself but also data, such as parameters and map information, used for execution of the program. The term “control program” represents the program and the data. Therefore, the update program includes not only a program for updating a program but also data for updating data used for execution of the program.

When the timing to update the control program has arrived, the management server 5 transmits update notification to the gateway 10 of the corresponding vehicle 1 (step S1). In step S1, update information (e.g., a destination URL where the update program is stored, the size of the update program, etc.) is transmitted together with a download request from the management server 5 to the gateway 10.

Upon receiving the update notification from the management server 5, the gateway 10 relays the update program downloaded from the DL server 6 to an ECU (hereinafter referred to as “target ECU”) 30 whose control program is to be updated. That is, the gateway 10 requests, to the DL server 6, download of the update program on the basis of the update information (step S2).

Upon receiving the download request from the gateway 10, the DL server 6 transmits the update program to be downloaded to the gateway 10, and requests update of the control program (step S3).

After downloading the update program, the gateway 10 transfers the update program to the target ECU 30, and requests update of the control program (step S4). The gateway 10 may transfer the update program when receiving permission for update from the user.

Upon receiving the update program, the target ECU 30 expands the update program and updates the control program in response to the request from the gateway 10 (step S5). The gateway 10 is an example of a control apparatus that controls an update process in the target ECU 30. When the gateway 10 has instructed the target ECU 30 to update the control program, the gateway 10 executes an update control process (step S6). The update control process is a process of controlling continuation of the update process started in the target ECU 30. The update control process will be described later.

Upon completing the update of the control program, the target ECU 30 notifies the gateway 10 of the completion of update (step S7). Upon receiving this notification, the gateway 10 notifies the DL server 6 of the completion of update (step S8).

### [Power Supply Configuration of Vehicle]

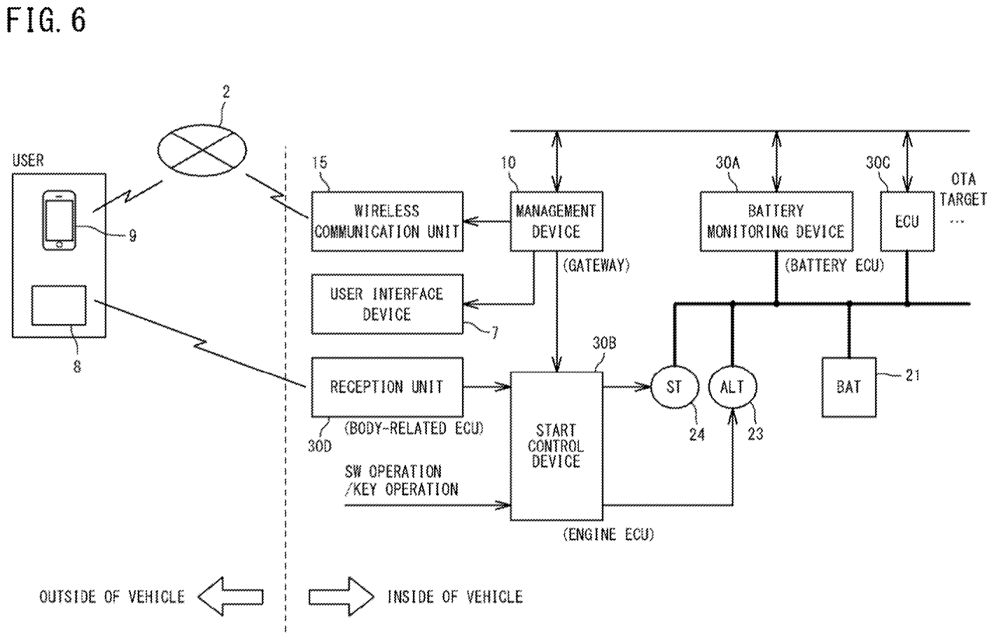

FIG. 6 is a schematic diagram showing an example of a configuration, including a power supply configuration, of a vehicle 1 according to the first embodiment. FIG. 6 shows an example of a configuration of a conventional type vehicle (engine car) which is also called a conventional car and is not a hybrid type vehicle. In FIG. 6, a thick solid line indicates a power line.

With reference to FIG. 6, the vehicle 1 according to the first embodiment includes a battery (BAT) 21 and an alternator (ALT) 23 which are power supplies.

The battery 21 supplies power to a battery monitoring device 30A that is an ECU for battery control, another ECU 30C, a starter (ST) 24 for starting up an engine, etc. In the program update system according to the first embodiment, it is assumed that an ECU such as the ECU 30C is a target ECU. Also, the ALT 23 is capable of supplying power to the above devices. Further, the battery 21 is charged with power generated in the ALT 23. That is, the ALT 23 is a mechanism for supplying power to the battery 21.

The starter 24 is connected to a start control device 30B that is an engine control ECU and controls start of the engine. Driving of the starter 24 is controlled by the start control device 30B. The start control device 30B controls the starter 24 to operate when the engine is started, and controls the starter 24 to stop when the engine has been started. The ALT 23 connected to the engine generates power while the engine is operated. Therefore, it can be said that the start control device 30B also controls the power generating operation of the ALT 23.

The start control device 30B is connected to a reception unit 30D that is a body-related ECU and receives a radio signal from the control terminal 8. The start control device 30B controls driving of the engine according to a user operation received from the control terminal 8 via the reception unit 30D. Further, the start control device 30B controls driving of the engine according to a user operation that is made on a switch, a key, or the like (not shown) and instructs start of the engine. In addition, the start control device 30B controls driving of the engine according to a user operation received from the communication device 9 via the wireless communication unit 15. Further, the start control device 30B is connected to the gateway 10 as an update process management device, and controls driving of the engine according to control from the gateway 10.

The gateway 10 is further connected to the battery monitoring device 30A, and acquires, from the battery monitoring device 30A, the battery state such as the state of charge of the battery 21. The gateway 10 executes the update control process when the control program of the ECU 30C as a target ECU is updated, and controls the start control device 30B according to this process. In addition, the gateway 10 is connected to the user interface device 7 or connected to the user interface device 7 via an ECU (not shown) for controlling a media device, and controls the user interface device 7 to output necessary information. In addition, the gateway 10 transfers information for output to the wireless communication unit 15 and causes the wireless communication unit 15 to transmit the output information so that necessary information is output to the communication device 9.

### [Update Control Process]

The update control process in step S6 in FIG. 5 includes the following STEPs 1 to 3.

STEP1: a first acquisition process of acquiring the state of charge of the battery 21;

STEP2: a second acquisition process of acquiring an estimated amount of power consumption in the vehicle 1 up to a time point when the update process in the target ECU 30 is completed; and

STEP3: a determination process of determining, based on the state of charge of the battery 21 and on the estimated amount of power consumption, whether or not an estimated state of charge of the battery 21 at the time point when the update process in the target ECU 30 is completed is insufficient.

According to the result of the determination process, the gateway 10 controls the update process in the target ECU 30. That is, the gateway 10 performs a control to increase the state of charge of the battery 21 when the gateway 10 determines, through the determination process, that the estimated state of charge is insufficient.

### [Functional Configuration of Gateway]

With reference to FIG. 2, the CPU 11 of the gateway 10 includes an update control unit 111 as a function of executing the update control process. The update control unit 111 includes a first acquisition unit 112 that executes a first acquisition process, a second acquisition unit 113 that executes a second acquisition process, and a determination unit 114 that executes a determination process. These functions are implemented in the CPU 11 when the CPU 11 reads out one or a plurality of programs stored in the storage unit 13, and executes the program. However, at least a part of the functions may be implemented by hardware such as an electronic circuit.

The function of the CPU 11 represented by the first acquisition unit 112 (hereinafter, this function is referred to as “first acquisition unit 112”) monitors a frame received from the ECU 30A that performs power supply control, and acquires a monitoring result of the state of the battery 21 from the ECU 30A. This monitoring result allows the first acquisition unit 112 to acquire a state of charge (SOC) of the battery 21 (hereinafter, also referred to as “battery SOC”).

The function of the CPU 11 represented by the second acquisition unit 113 (hereinafter, this function is referred to as “second acquisition unit 113”) acquires, based on the power consumption state of the vehicle 1 at the time point when the battery SOC is acquired in the first acquisition unit 112, an estimated amount of power consumption (hereinafter, also referred to simply as “estimated power consumption”) DW in a period from the SOC acquisition time point to the completion of the update process in the target ECU 30. The estimated power consumption DW consists of: an amount of power DW1 required in the target ECU in the period from the SOC acquisition time point to the completion of the update process; and an amount of power DW2 that is estimated to be consumed in ECUs other than the target ECU during the period. The amount of power DW2 can be regarded as a total sum of the amounts of power estimated to be consumed in the period from the SOC acquisition time point to the completion of the update process in the target ECU by all the ECUs other than the target ECU among the plurality of ECUs 30 mounted in the vehicle 1.

The second acquisition unit 113 may monitor a frame received from the ECU 30A to acquire current consumption at the SOC acquisition time point in the target ECU during the update process or an average value of current consumption during a predetermined period before and after the SOC acquisition time point, and may calculate the amount of power DW1 by multiplying the current consumption by a remaining time up to the completion of the update process. Likewise, the second acquisition unit 113 may monitor a frame received from the ECU 30A to acquire current consumption in devices other than the target ECU or an average value thereof, and may calculate the amount of power DW2 by multiplying the current consumption by the remaining time up to the completion of the update process. In another example, the second acquisition unit 113 may acquire the amount of power DW1 from the management server 5, or may calculate the amount of power DW1 based on the size of the update program and the through-put of the target ECU which are acquired from the management server 5.

The function of the CPU 11 represented by the determination unit 114 (hereinafter this function is referred to as “determination unit 114”) calculates an estimated SOC′ on the basis of the battery SOC and the estimated power consumption DW. For example, the determination unit 114 subtracts the estimated power consumption DW from the battery SOC to obtain an estimated SOC′ (=SOC−DW). The determination unit 114 stores in advance a threshold Th regarding an amount of power, and compares the estimated SOC′ with the threshold Th. The threshold Th is, for example, a prescribed margin (safety margin) or the like, and indicates a minimum amount of power required for the vehicle 1 to operate. The determination unit 114 compares the estimated SOC′ with the threshold Th (first determination). When the estimated SOC′ is smaller (less) than the threshold Th, the determination unit 114 determines that the estimated SOC′ is insufficient. When the estimated SOC′ is larger (more) than the threshold Th, the determination unit 114 determines that the estimated SOC′ is not insufficient.

The function of the CPU 11 represented by the update control unit 111 (hereinafter this function is referred to as “update control unit 111”) controls the update process in the target ECU 30 according to the determination result in the determination unit 114. When the determination unit 114 determines, in the first determination process, that the estimated SOC′ is not insufficient, the update control unit 111 executes a control to continue the update process in the target ECU. That is, in this case, the update control unit 111 does not execute a control for the target ECU to suspend update, and a control to cause the user interface device 7 to make notification described later. Also, in this case, the update control unit 111 does not execute a charging process for the battery 21 described below.

When the determination unit 114 determines, in the first determination process, that the estimated SOC′ is insufficient, the update control unit 111 executes the charging process for the battery 21. Thus, the battery SOC is increased.

In the engine car shown in FIG. 6, when an engine (not shown) is started by activating the starter 24, the ALT 23 starts to generate power, and the generator power is supplied to the battery 21. Therefore, in order to charge the battery 21, a user operation to instruct the start of the engine is necessary. This user operation is also regarded as a charging start operation. Therefore, the update control unit 111 executes a process of requesting the user to perform the charging start operation (request process). The request process is a process of causing the user interface to output, to the user, information that urges the user to make a charging start instruction (start operation urging information).

The user operation includes first to third operations as follows.

First operation: an operation using a user interface such as a switch or a key (not shown) provided in the vehicle 1;

Second operation: an operation using the control terminal 8; and Third operation: an operation using the communication device 9 such as a smartphone.

The first operation is an operation that is possible when the user is inside the vehicle, while the second and third operations are operations that are possible regardless of whether the user is inside or outside the vehicle.

In the first operation, an operation signal is input to the start control device 30B from the user interface. In the second operation, an operation signal is received by the reception unit 30D and input to the start control device 30B. These user operations are detected by the gateway 10 that monitors a transmission signal from the start control device 30B. In the third operation, an operation signal is received by the wireless communication unit 15 via the wide-area communication network 2, and is input to the gateway 10.

The request process includes a request process in the case where the user is inside the vehicle (first request process), and a request process in the case where the user is not inside the vehicle (second request process). Whether or not the user is inside the vehicle can be determined by, for example, determining whether or not the control terminal 8 carried by the user is within a wirelessly communicable range, through monitoring of the frame from the ECU 30D communicating with the control terminal 8. In another example, whether or not the user is seated inside the vehicle may be determined by using a seating sensor (not shown) provided in a seat in the vehicle, or whether or not the user is inside the vehicle may be determined by analyzing an image captured by an in-vehicle camera (not shown).

When the user is inside the vehicle, the update control unit 111 executes the first request process. The first request process is a process of causing the user interface device 7 to output the start operation urging information. When the user interface device 7 is a display, the start operation urging information is a screen that requests engine start. When the user interface device 7 is a speaker, the start operation urging information is a voice message that requests engine start. For this purpose, the update control unit 111 generates a frame including data for output, and causes an in-vehicle communication unit 14 to transmit the frame to the user interface device 7.

When the user is not inside the vehicle, the update control unit 111 executes the second request process. The second request process is a process of transmitting the start operation urging information to the communication device 9 of the user registered in advance. For this purpose, the update control unit 111 generates a frame including data for transmission, inputs the frame to the wireless communication unit 15, and causes the wireless communication unit 15 to transmit the start operation urging information.

Upon detecting the charging start operation, the update control unit 111 instructs the start control device 30B to start the engine. Specifically, the update control unit 111 generates a frame including data that instructs engine start, and causes the in-vehicle communication unit 14 to transmit the frame to the start control device 30B.

Preferably, in advance of the first determination, the determination unit 114 compares the battery SOC with the threshold Th (second determination). When the battery SOC is smaller (less) than the threshold Th, the determination unit 114 determines that the battery SOC is insufficient. When the battery SOC is larger (more) than the threshold Th, the determination unit 114 determines that the battery SOC is not insufficient.

When the determination unit 114 determines, in the first determination process, that the battery SOC is insufficient, the update control unit 111 instructs the target ECU to suspend update. Specifically, the update control unit 111 generates a frame including data that instructs suspension of update, and causes the in-vehicle communication unit 14 to transmit the frame to the target ECU. Thus, the update process in the target ECU is suspended.

Preferably, when the determination unit 114 determines, in the first determination process, that the battery SOC is not insufficient, the determination unit 114 executes a second determination process. That is, when the determination unit 114 determines that the battery SOC is not insufficient and the estimated SOC′ is insufficient, the update control unit 111 executes a charging process for the battery 21.

[Operation Flow]

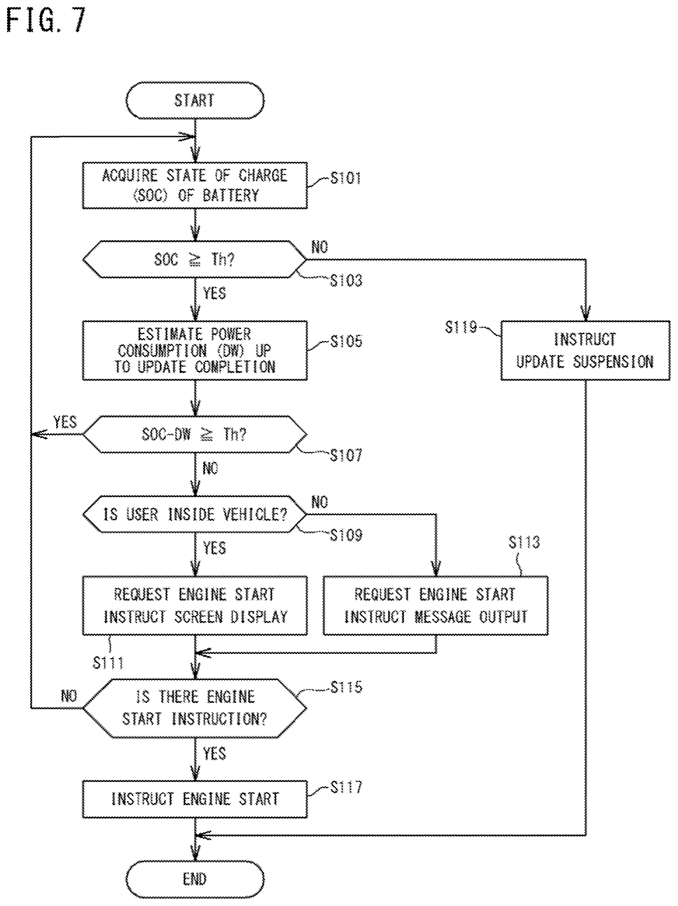

FIG. 7 is a flowchart showing a specific example of the update control process in step S6 shown in FIG. 5. The process shown in the flowchart of FIG. 7 is executed when the respective functions shown in FIG. 2 are implemented by the CPU 11 of the gateway 10 reading out one or a plurality of programs stored in the storage unit 13 onto the RAM 12 and executing the programs. The process shown in FIG. 7 is started when the gateway 10 requests the target ECU to perform update in step S4 in FIG. 5.

With reference to FIG. 7, first, the CPU 11 executes the second determination process described above. That is, the CPU 11 monitors a frame from the ECU 30A, and acquires a battery SOC (step S101). Then, the CPU 11 compares the battery SOC with the threshold Th stored in advance.

When the battery SOC is smaller than the threshold Th (NO in step S103), the CPU 11 instructs suspension of the update process in the target ECU (step S119).

When the battery SOC is equal to or larger than the threshold Th (YES in step S103), the CPU 11 further executes the first determination process. That is, the CPU 11 calculates an estimated power consumption DW that is power consumption estimated up to completion of update, on the basis of the current power consumption state (step S105), and subtracts the estimated power consumption DW from the current battery SOC to obtain an estimated SOC′ (=SOC−DW). Then, the CPU 11 compares the estimated SOC′ (=SOC−DW) with the threshold Th.

When the estimated SOC′ is smaller than the threshold Th (NO in step S107), the CPU 11 executes the request process. At this time, the request process branches to the first request process or the second request process depending on whether or not the user is inside the vehicle. Therefore, the CPU 11 determines whether or not the user is inside the vehicle by, for example, monitoring a frame from the ECU 30D communicating with the control terminal 8.

Upon determining that the user is inside the vehicle (YES in step S109), the CPU 11 executes the first request process. That is, the CPU 11 causes the user interface device 7 which is a display, for example, to display a screen that requests the user to start the engine (step S111).

Upon determining that user is not inside the vehicle (NO in step S109), the CPU 11 executes the second request process. That is, the CPU 11 transmits the start operation urging information to the communication device 9 of the user of the vehicle 1 registered in advance (step S113).

Upon detecting a charging start operation after the first request process in step S111 or the second request process in step S113 (YES in step S115), the CPU 11 instructs the start control device 30B to start the engine (step S117). Then, the CPU 11 ends the series of operations.

When a charging start operation has not been detected within a predetermined period after the first or second request process (NO in step S115), the CPU 11 does not instruct the start control device 30B to start the engine. Also, when the estimated SOC′ is larger than the threshold Th in the second determination process (YES in step S107), the CPU 11 does not instruct the start control device 30B to start the engine.

When the estimated SOC′ is smaller than the threshold Th and a charging start operation has not been detected within the predetermined period (NO in step S115), the battery SOC will become insufficient at least when update is completed. Also, even when the estimated SOC′ is equal to or larger than the threshold Th (YES in step S107), the battery SOC may become insufficient depending on the power consumption states in the ECUs other than the target ECU during update. Therefore, preferably, the CPU 11 repeats the processes from step S101 after a predetermined time has passed from the request process or after a predetermined time has passed from the first determination process. Thus, if the estimated SOC′ becomes insufficient while the update process progresses, the CPU 11 urges the user to perform a user operation to instruct engine start, thereby increasing the battery SOC. Further, when the battery SOC becomes insufficient, the CPU 11 can suspend the update process. Thus, it is possible to avoid the situation that the insufficient battery SOC causes the update process to stop, and the situation that the battery SOC becomes insufficient for traveling after completion of the update process.

### [Effects of First Embodiment]

In the program update system according to the first embodiment, when it is estimated, during update of a control program, that the battery SOC will become insufficient at completion of the update, the user is urged to perform the charging start operation. When the charging start operation is performed, the engine is driven in the vehicle 1 of the present embodiment. With the engine start, the ALT 23 generates power, and the battery 21 is charged with the generated power. Thus, it is possible to avoid the situation that the update is suspended due to insufficient battery SOC during the update, and the update is failed or the update program is damaged. In addition, it is possible to avoid the battery SOC from being in the insufficient state after completion of the update.

Further, in the program update system according to the first embodiment, when the battery SOC at completion of update is estimated, not only power consumption required in the target ECU but also an estimation value of power consumption up to completion of update which is estimated based on current power consumption in other devices, are considered. Thus, the battery SOC can be estimated with high accuracy.

### <Modifications>

Control of engine operation in the gateway 10 may include a normal operation mode in which the engine is operated in the state where the vehicle 1 is traveling, and an update operation mode in which the engine is operated for charging the battery 21 during the update process. In the normal operation mode, when the engine is started up, the gateway 10 may cause other functions such as an air conditioner and an audio to simultaneously start up according to setting. In the update operation mode, regardless of the setting in the normal operation mode, the gateway 10 causes only the engine to start up. Thus, the battery 21 can be efficiently charged. This control is the same in the second and third embodiments described below.

### Second Embodiment

In a program update system according to a second embodiment, after charging of the battery 21 has been started, the mechanism for supplying power to the battery 21 is caused to stop the supply of power to the battery 21 when the battery 21 is sufficiently charged. In the vehicle 1 according to the first embodiment, the mechanism for supplying power to the battery 21 is the ALT 23, and the operation of the engine is stopped to stop the supply of power from the ALT 23. For this purpose, the update control process of the program update system according to the second embodiment includes a control to stop the operation of the engine after engine start has been instructed in step S117 in FIG. 7. Therefore, after determining, in the first determination process, that the estimated SOC′ is insufficient and instructing engine start in step S117 in FIG. 7, the determination unit 114 of the second embodiment further executes a third determination process of determining whether or not engine stop is necessary. A similar control may be performed in a program update system according to a third embodiment described below.

In order to execute the third determination process, the first acquisition unit 112 acquires the battery SOC after the engine has been started. In addition, the second acquisition unit 113 acquires the estimated power consumption DW after the engine has been started. The determination unit 114 calculates an estimated SOC′, based on the battery SOC and the estimated power consumption DW acquired after the engine start, and compares the estimated SOC′ with the threshold Th. The method of calculating the estimated power consumption DW is the same as the calculation method adopted by the determination unit 114 according to the first embodiment.

In the third determination process, when the estimated SOC′ (=SOC−DW) is larger than the threshold Th (SOC′>Th), the determination unit 114 determines that the estimated SOC′ is not insufficient. This means that, after the engine start, the battery SOC has been increased up to the state where the estimated SOC′ becomes not insufficient. According to the determination result in the third determination process, the update control unit 111 generates a frame including data that instructs engine stop, and causes the in-vehicle communication unit 14 to transmit the frame to the ECU 30B that controls the engine. Thus, the engine is stopped.

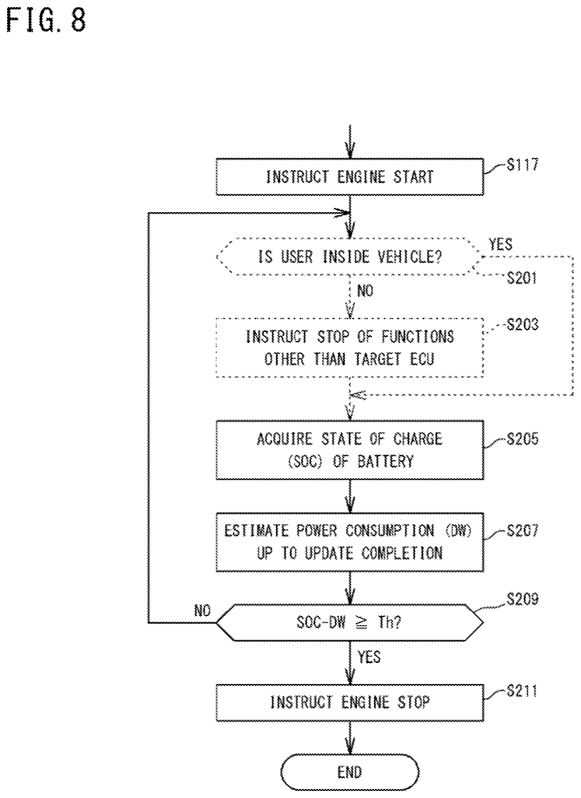

FIG. 8 is a flowchart showing a specific example of the update control process in step S6 in FIG. 5. FIG. 8 is a flowchart showing an operation performed after the operation shown in the flowchart of FIG. 7.

With reference to FIG. 8, after instructing engine start in step S117 in FIG. 7, the CPU 11 executes the third determination process. That is, the CPU 11 monitors a frame from the ECU 30A, and acquires a battery SOC (step S205). In addition, the CPU 11 calculates an estimated power consumption DW up to completion of update, based on the current power consumption state (step S207), and subtracts the estimated power consumption DW from the current battery SOC, thereby calculating an estimated SOC′ (=SOC−DW). This calculation process is identical to step S105 in FIG. 7. Then, the CPU 11 compares the estimated SOC′ (=SOC−DW) with the threshold Th.

When the estimated SOC′ is smaller than the threshold Th (NO in step S209), the CPU 11 does not instruct engine stop, and causes the engine to continue operating. Preferably, the CPU 11 repeats the above process after a predetermined time has passed from the third determination process in step S209.

When the estimated SOC′ is equal to or larger than the threshold Th (YES in step S209), the CPU 11 instructs the start control device 30B to stop the engine (step S211). Then, the CPU 11 ends the series of operations.

### [Effect of Second Embodiment]

In the program update system according to the second embodiment, in the case where it is estimated that the battery SOC will become insufficient at completion of update and therefore the engine is started to ensure the battery SOC in the program update system according to the first embodiment, operation of the engine is stopped when a necessary battery SOC has been ensured. Therefore, a necessary battery SOC is ensured without performing unnecessary engine operation.

### <Modifications>

With reference to FIG. 8, preferably, when it is determined that the user is not inside the vehicle after engine start has been instructed in step S117 (NO in step S201), the CPU 11 instructs ECUs other than the target ECU to stop other functions (step S203). The other functions correspond to, for example, an air conditioner, an audio, etc.

Even when the user is not inside the vehicle, ON/OFF of an air conditioner or an audio may be controlled through the second operation or the third operation. For example, a case is assumed in which the inside of the vehicle cabin should be set at an appropriate temperature before driving. However, when these functions are being operated, the battery SOC decreases more. Therefore, power consumption in the vehicle 1 can be reduced by stopping these functions.

This control is not limited to the program update system of the second embodiment, and may be performed in or after step S117 in the program update system according to the first embodiment. Furthermore, this control may be executed in the program update system according to a third embodiment described below.

### Third Embodiment

In the first and second embodiments, the vehicle 1 is a so-called engine car. However, even when the vehicle 1 is an electric motor vehicle having no engine and no alternator, the same update control process as described above may be performed on the vehicle 1.

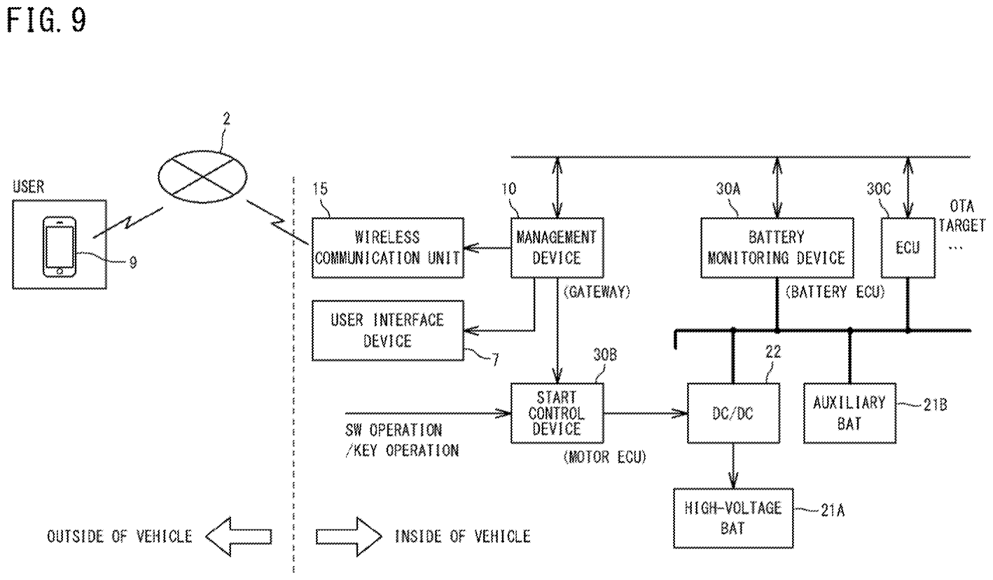

FIG. 9 is a schematic diagram showing an example of a configuration, also including a power supply configuration, of a vehicle 1 according to the third embodiment. FIG. 9 shows an example of a configuration of an electric motor vehicle (electric car). In FIG. 9, a thick solid line indicates a power line.

With reference to FIG. 9, the vehicle 1 according to the third embodiment includes, as power supplies, a high-voltage battery 21A, and an auxiliary battery 21B for system start-up and for supply of power to the respective devices, instead of the battery 21, the ALT 23, and the starter 24 of the vehicle 1 according to the first embodiment (FIG. 6).

The high-voltage battery 21A is a battery for traveling that supplies power to a motor driving device (not shown) to start a driving system, and is also a battery for charging that supplies power to the auxiliary battery 21B while stepping down a voltage through a DC/DC converter 22. The auxiliary battery 21B supplies power to the battery monitoring device 30A and another ECU 30C. Also, in the program update system according to the third embodiment, an ECU such as the ECU 30C is a target ECU. In addition, the auxiliary battery 21B is charged with the power supplied from the high-voltage battery 21A via the DC/DC converter 22. That is, the high-voltage battery 21A and the DC/DC converter 22 implement a mechanism for supplying power to the auxiliary battery 21B.

In the vehicle 1 according to the third embodiment, the start control device 30B controls start of a driving system (not shown), and controls ON/OFF and an output voltage of the DC/DC converter 22. When the DC/DC converter 22 is turned on, power is supplied from the high-voltage battery 21A to the auxiliary battery 21B, and the auxiliary battery 21B is charged with the supplied power. When the DC/DC converter 22 is turned off, supply of power from the high-voltage battery 21A to the auxiliary battery 21B is stopped, and thus charging of the auxiliary battery 21B is stopped. That is, the start control device 30B also controls charging of the auxiliary battery 21B.

The start control device 30B controls ON/OFF of the DC/DC converter 22 in accordance with a user operation performed on a switch, a key, or the like (not shown). In addition, the start control device 30B controls ON/OFF of the DC/DC converter 22 according to a user operation received from the communication device 9 via the wireless communication unit 15. Further, the start control device 30B is connected to the gateway 10 as an update process management apparatus, and controls ON/OFF of the DC/DC converter 22 in accordance with control of the gateway 10. The gateway 10 is further connected to the battery monitoring device 30A, and acquires a battery state, such as a state of charge, of the high-voltage battery 21A from the battery monitoring device 30A.

An update control process in the program update system according to the third embodiment is almost the same as the update control process in the program update system according to the first embodiment shown in FIG. 7. In the program update system according to the third embodiment, the CPU 11 of the gateway 10 executes the update control process based on a battery SOC′ of the auxiliary battery 21B.

In the electric car shown in FIG. 9, when the DC/DC converter 22 is turned on, power is supplied from the high-voltage battery 21A to the auxiliary battery 21B, whereby the auxiliary battery 21B is charged. Therefore, in order to charge the auxiliary battery 21B, a user operation that instructs turn-on of the DC/DC converter 22 is necessary. In this third embodiment, a charging start operation is a user operation that instructs turn-on of the DC/DC converter 22. With reference to FIG. 7, in the program update system according to the third embodiment, when the battery SOC′ is smaller than the threshold Th (NO in step S107), the CPU 11, in step S111 or S113, outputs start operation urging information that requests the user to perform a charging start operation which is an operation to turn on the DC/DC converter 22. Upon detecting the charging start operation, the CPU 11 instructs the start control device 30B to turn on the DC/DC converter 22 instead of engine start (step S117).

As described above, even when the vehicle 1 is an electric car, the above-described update control process being executed avoids the situation that update is suspended due to an insufficient battery SOC during the update, and the update is failed or the update program is damaged.

The disclosed feature is implemented by one or more modules. For example, the feature can be implemented by: hardware modules such as circuit elements, etc.; software modules defining processes that realize the feature; or a combination of the hardware modules and the software modules.

The disclosed feature may be provided as a program, which is a combination of one or more software modules, for causing a computer to execute the aforementioned operation. Such a program may be recorded in a computer-readable recording medium, such as a flexible disc, a CD-ROM (Compact Disk-Read Only Memory), an ROM, an RAM, a memory card, or the like adjunct to the computer, and provided as a program product. Alternatively, the program may be provided by being recorded in a recording medium such as a hard disk incorporated in the computer. The program may also be provided by being downloaded through a network.

The program according to the present disclosure may call up necessary modules in a predetermined array at a predetermined timing from among program modules provided as a portion of an operating system (OS) of a computer, and may cause processing to be executed. In this case, the modules are not included in the program itself, and the processing is executed in cooperation with the OS. The program according to the present disclosure also includes such a program including no modules.

The program according to the present disclosure may be provided by being incorporated in a portion of another program. In that case as well, modules included in the other program are not included in the program itself, and processing is executed in cooperation with the other program. The program according to the present disclosure also includes such a program incorporated in another program. A program product to be provided is installed in a program storage unit such as a hard disk, and then executed. The program product includes the program itself and a recording medium in which the program is recorded.

It is noted that the embodiments disclosed herein are merely illustrative in all aspects and should not be recognized as being restrictive. The scope of the present invention is defined not by the above description but by the scope of the claims, and is intended to include meaning equivalent to the scope of the claims and all modifications within the scope.

### REFERENCE SIGNS LIST

1 vehicle
2 wide-area communication network
4 communication network
5 management server
6 DL server
7 user interface device
8 operation terminal
9 communication device (user interface device)
10 gateway, management device (control apparatus)
11 CPU
12 RAM
13 storage unit
14 in-vehicle communication unit
15 wireless communication unit
16 in-vehicle communication line
21 battery
21A high-voltage battery
21B auxiliary battery
22 DC/DC converter
23 ALT
24 starter
30 ECU
30A battery monitoring device (ECU)
30B start control device (ECU)
30D reception unit (ECU)
31 CPU
32 RAM
33 storage unit
34 communication unit
35 start-up unit
51 CPU
52 ROM
53 RAM
54 storage unit
55 communication unit
111 update control unit
112 first acquisition unit
113 second acquisition unit
114 determination unit

1-12. (canceled)

13. A charging necessity determination apparatus configured to determine whether or not charging of an on-vehicle battery is necessary,
the apparatus comprising an information processing unit and a random access memory, wherein
the information processing unit is configured to execute:
an acquisition process of acquiring a state of charge of the on-vehicle battery, and an estimated amount of power to be consumed, by a plurality of on-vehicle control devices including an on-vehicle control device as an update target, up to a time point when update of a control program by the on-vehicle control device as the update target is completed; and
a determination process of determining whether or not to output information that causes charging of the on-vehicle battery to be executed, on the basis of the state of charge of the on-vehicle battery and the estimated amount of power.

14. The charging necessity determination apparatus according to claim 13, wherein
the information processing unit calculates an estimated state of charge of the on-vehicle battery at the time point of update completion, on the basis of the state of charge of the on-vehicle battery and the estimated amount of power, and
the determination process executed by the information process unit includes a first determination process of determining whether or not the estimated state of charge of the on-vehicle battery is equal to or larger than a predetermined threshold.

15. The charging necessity determination apparatus according to claim 14, wherein
the information processing unit determines to output the information when the estimated state of charge of the on-vehicle battery is smaller than the threshold.

16. The charging necessity determination apparatus according to claim 15, wherein
when a user is not inside a vehicle, the information processing unit causes a wireless communication unit connected to the charging necessity determination apparatus to transmit a communication frame that causes a user interface device outside the vehicle to perform output of the information.

17. The charging necessity determination apparatus according to claim 15, wherein
when the user is inside a vehicle, the information processing unit causes a wireless communication unit connected to the charging necessity determination apparatus to transmit a communication frame that causes an on-vehicle user interface device to perform output of the information.

18. The charging necessity determination apparatus according to claim 14, wherein
the information processing unit, after charging of the on-vehicle battery has been started, further calculates an estimated state of charge of the on-vehicle battery at the time point of update completion, on the basis of the state of charge of the on-vehicle battery and the estimated amount of power, and
the information processing unit causes a mechanism for supplying power to the on-vehicle battery to stop the supply of power, on a condition that the estimated state of charge having been further calculated is equal to or larger than the predetermined threshold.

19. The charging necessity determination apparatus according to claim 14, wherein
the determination process executed by the information processing unit includes a second determination process of determining, in advance of the first determination process, whether or not the state of charge of the on-vehicle battery is equal to or larger than the predetermined threshold, and
the information processing unit
executes the first determination process when the state of charge of the on-vehicle battery is equal to or larger than the threshold, and
causes the update target to stop the update when the state of charge of the on-vehicle battery is smaller than the threshold.

20. The charging necessity determination apparatus according to claim 19, wherein
when the estimated state of charge of the on-vehicle battery is equal to or larger than the threshold, the information processing unit determines not to output the information, and repeatedly executes the first determination process and the second determination process.

21. The charging necessity determination apparatus according to claim 19, wherein
in a case where the information processing unit does not detect an instruction to start charging after determining to perform output of the information because the estimated state of charge of the on-vehicle battery is smaller than the threshold, the information processing unit repeatedly executes the first determination process and the second determination process.

22. The charging necessity determination apparatus according to claim 13, wherein
the information is at least one of:
information that causes a user to execute start of an engine; and
information that causes the user to execute an operation to turn on a DC/DC converter configured to supply power from a battery for traveling to an auxiliary battery.

23. The charging necessity determination apparatus according to claim 13, wherein
the estimated amount of power includes: a first amount of power to be consumed by the update target in a period from a time point when the state of charge of the on-vehicle battery is acquired to the time point when the update is completed; and a second amount of power to be consumed by an on-vehicle control device other than the update target in the period.

24. The charging necessity determination apparatus according to claim 23, wherein
the information processing unit calculates the first amount of power and the second amount of power, on the basis of current consumption at the time point when the state of charge of the on-vehicle battery is acquired, or an average value of power consumption within a predetermined period including the time point of the acquisition.

25. The charging necessity determination apparatus according to claim 13, wherein
the information processing unit outputs information that causes predetermined equipment other than an engine to stop during the update of the control program by the update target.

26. A method of determining whether or not charging of an on-vehicle battery is necessary, the method being executed by a computer including an information processing unit and a random access memory, the method comprising the steps of:
acquiring, by the information processing unit, a state of charge of the on-vehicle battery, and an estimated amount of power to be consumed, by a plurality of on-vehicle control devices including an on-vehicle control device as an update target, up to a time point when update of a control program by the on-vehicle control device as the update target is completed; and
determining, by the information processing unit, whether or not to output information that causes charging of the on-vehicle battery to be executed, on the basis of the state of charge of the on-vehicle battery and the estimated amount of power.

27. A non-transitory computer readable storage medium storing a computer program for causing a computer including an information processing unit and a random access memory to function as an apparatus for determining whether or not charging of an on-vehicle battery is necessary, the computer program comprising the steps of:
acquiring, by the information processing unit, a state of charge of the on-vehicle battery, and an estimated amount of power to be consumed, by a plurality of on-vehicle control devices including an on-vehicle control device as an update target, up to a time point when update of a control program by the on-vehicle control device as the update target is completed; and
determining, by the information processing unit, whether or not to output information that causes charging of the on-vehicle battery to be executed, on the basis of the state of charge of the on-vehicle battery and the estimated amount of power.
